(19) United States
(12) Patent Application Publication
(10) Pub. No.: US 2006/0288422 A1
(43) Pub. Date: Dec. 21, 2006

(54) Data structure for identifying hardware and software licenses to distribute with a complying device

(75) Inventors: Yue Liu, Issaquah, WA (US); Caglar Gunyakti, Sammamish, WA (US); Andrew J. Ritz, Sammamish, WA (US); Todd Haugen, Clyde Hill, WA (US); Stephanie Ybarra, Issaquah, WA (US); Douglas Rex Thompson, Bothell, WA (US); Mark Kyle Svancarek, Redmond, WA (US); Joshua David Kriesberg, Seattle, WA (US); John Peter Hakan Olsson, Kirkland, WA (US); Allen Edward Nieman, Redmond, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/157,886

(22) Filed: Jun. 21, 2005

(51) Int. Cl. H04N 7/16

(52) U.S. Cl. 726/26

(57) ABSTRACT

Systems and methods for software licensing enforcement using an ACPI BIOS. A digital license is provided that includes information about both the software and hardware on which it is to be run. The licensing process receives hardware and software information from the end user and binds the license to both. A main BIOS binary contains code and static motherboard specific data. Dynamic state values containing, e.g., machine-specific system management data, such as, a serial number may be stored subsequently on NVRAM or its equivalent. The main BIOS binary allows provides sufficient functionality to test the hardware. Once the software to be loaded on the system is known, a corresponding digital license containing both the software and hardware information is loaded to NVRAM.

### FIELD OF THE INVENTION

This invention relates in general to the field of computer hardware and software distribution. More particularly, this invention relates to a data structure that identifies if software can be distributed and loaded on to a particular hardware device.

### BACKGROUND OF THE INVENTION

Conventionally, software has been licensed for per device usage. However, there have been limited methods to enforce licensee obligations, which has led to software being installed on multiple, unlicensed machines. Digital licenses improved upon shrink wrap licenses, and are used to limit a piece of software to a particular piece of hardware, where the digital license contains both software and hardware information.

One problem with digital licenses is that every year, over 100 million personal computers are shipped to end customers by OEMs (original equipment manufactures). Asking every end user to acquire the digital license for the copy of software and for the specific machine is not practical. A partial solution to this problem was used in new computers “pre-loaded” with MICROSOFT WINDOWS XP. OEMs were provided the ability to “pre-activate” WINDOWS XP by using a mechanism called “System Locked Pre-installation,” SLP.

SLP uses information stored in the OEM's personal computer BIOS to protect the installation from casual piracy. No communication by the end customer to MICROSOFT is required and no hardware hash is created or necessary. At boot, WINDOWS XP compares the PC's BIOS to the SLP information. If it matches, no activation is required. Thus, every single piece of hardware could be changed on a PC with SLP and no reactivation would be required. However, a limitation of this method is that the OEM information in the BIOS could be written simply by flashing it to the BIOS. Thus, it could be written to the BIOS of an unauthorized machine to make the unauthorized machine appear as an authorized machine.

Thus, it is desirable that a digital license contain information related to the software and hardware that will be pre-loaded by manufacturers, and that the digital license persist through the system life cycle, such as hard drive corruption or image based installation. It is also desirable that the digital license information not be easily forged onto an unauthorized PC. The present invention provides such a solution to these and other problems.

### SUMMARY OF THE INVENTION

The present invention extends the usage of the ACPI BIOS for software licensing enforcement. ACPI is the acronym for advanced configuration and power interface. A digital license is provided that includes information about both the software and hardware on the computing device on which software may be run. The licensing process receives hardware and software information from the end user and binds the license to both. In accordance with the present invention, a main BIOS binary (in ROM or its equivalent) contains code and static motherboard specific data. Dynamic state values containing, e.g., machine-specific system management data, such as, a serial number may be stored subsequently on NVRAM or its equivalent. The main BIOS binary allows provides sufficient functionality to test the hardware. Once the software to be loaded on the system is known, a corresponding digital license containing both the software and hardware information is loaded to NVRAM.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram showing an exemplary computing environment in which aspects of the invention may be implemented;

FIG. 2 is an exemplary ACPI BIOS table in accordance with the present invention; and

FIG. 3 illustrates the software licensing structure shown in FIG. 2.

### DETAILED DESCRIPTION OF PREFERRED EMBODIMENTS

Exemplary Computing Environment

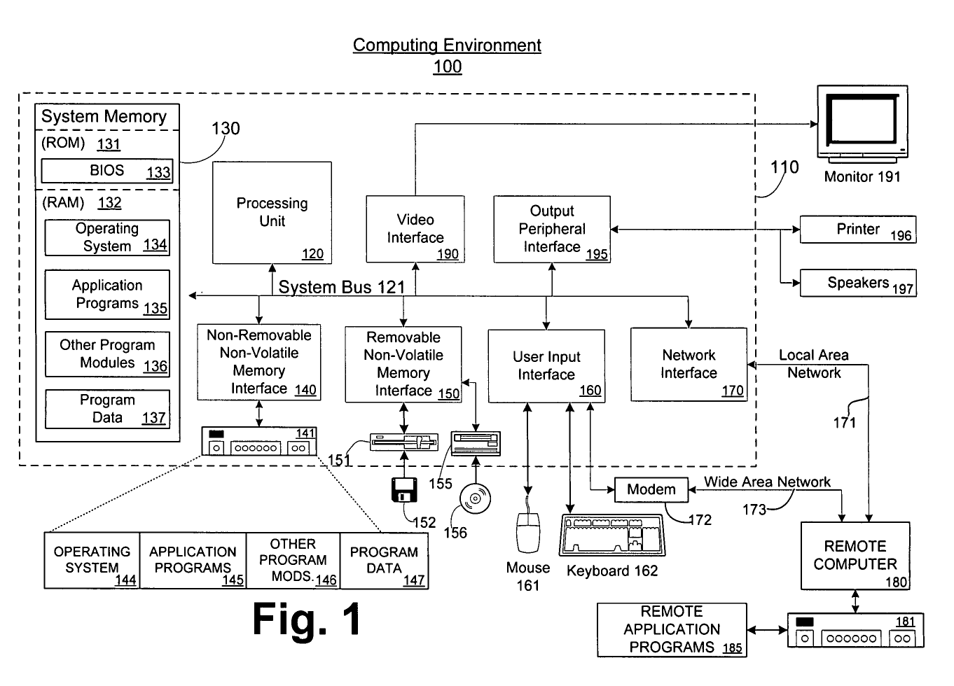

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus (also known as Mezzanine bus), Peripheral Component Interconnect Express (PCI-Express), and Systems Management Bus (SMBus).

Computer 110 typically includes a variety of computer readable media. Computer readable media can be any available media that can be accessed by computer 110 and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or non-volatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/non-volatile computer storage media. By way of example only, FIG. 1 illustrates a hard disk drive 141 that reads from or writes to non-removable, non-volatile magnetic media, a magnetic disk drive 151 that reads from or writes to a removable, non-volatile magnetic disk 152, and an optical disk drive 155 that reads from or writes to a removable, non-volatile optical disk 156, such as a CD-ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Exemplary Embodiments

The present invention is directed to a data structure within an ACPI BIOS table that exposes licensing information. The ACPI system firmware describes the system's characteristics by placing data, organized into tables, into main memory. These tables have names like RSDT and DSDT. The DSDT (Differentiated System Description Table) is the largest table, because this is where the system's devices are described. The present invention builds upon this structure by implementing a Software Licensing table called, e.g., SLIC.

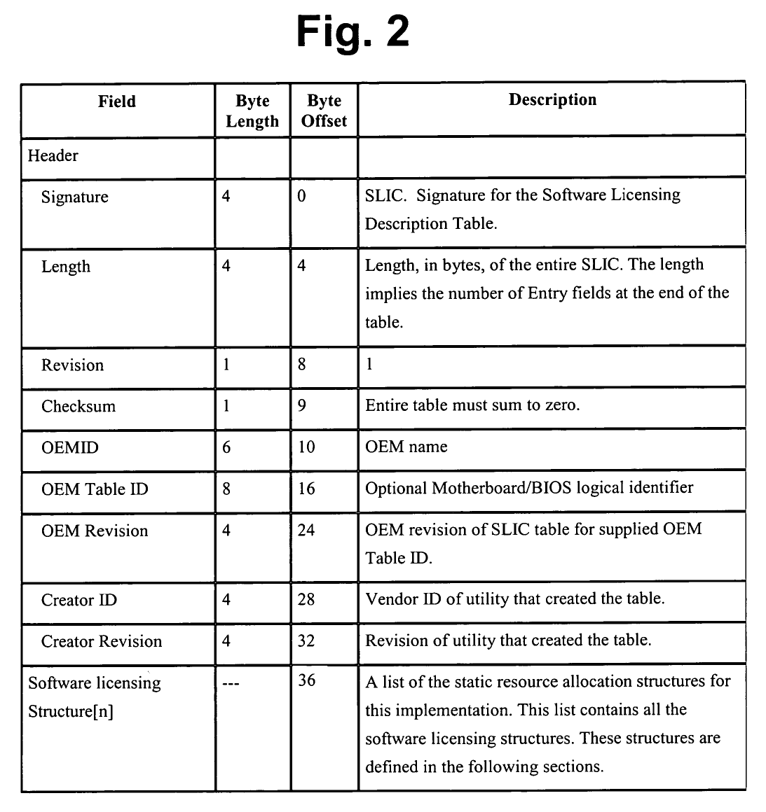

The ACPI_SLIC system table structure exposes licensing information that is persisted on the motherboard to a licensing enforcement engine in, e.g., the operating system. The ACPI_SLIC advantageously shares the same header structure as other ACPI tables, as shown in FIG. 2. In addition two additional data structures are provided: (1) digitally signed license data, and (2) public key in verifying the signature of digital license mentioned above.

The digital license data in the ACPI_SLIC is preferably small because persistent memory on motherboard is expensive. It is preferable that digital license contain at least the following pieces of data: (1) hardware information, for example, individual hardware ID or motherboard type ID, (2) software information, for example, a product key or operating system flag, (3) timestamp, and a digital signature, based on, but not limited to, RSA1024. The digital license in ACPI_SLIC is preferably an opaque string. How an operating system interprets the data is governed by the type value.

The public key to verify the digital license in item (1) above, may be implemented on a special piece of hardware on the motherboard, embedded in the BIOS, etc. For standardized operating system retrieval, this verifier of digital signature is also exposed through ACPI_SLIC.

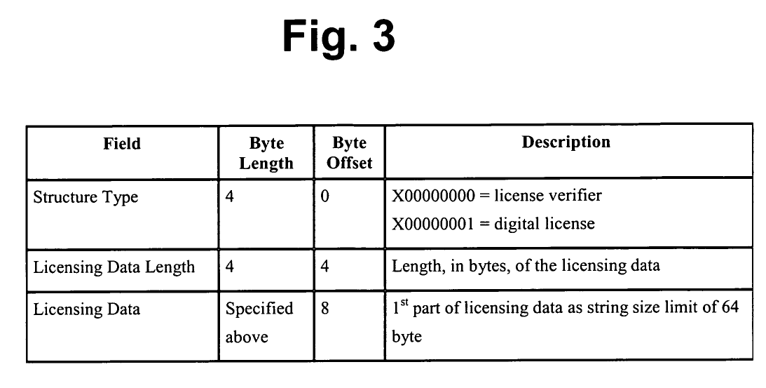

The software licensing structure shown in FIG. 2 is further defined in FIG. 3. The software licensing structure includes the digital license and its signature verifier, which are exposed and differentiated by the value of structure type.

The present invention supports a flexible manufacturing process for the ACPI BIOS. The BIOS may be conceptually viewed as two parts:

1. Main BIOS binary, on ROM or its equivalent, containing code and static motherboard specific data; and

2. Dynamic state values, on NVRAM or its equivalent, containing system management data, such as a serial number.

The former is motherboard specific and the later is individual machine specific.

During early stage of PC manufacture, an OEM may not necessarily know what software will be loaded on that specific PC for end user during shipping time. However, the OEM may need the full functional firmware/BIOS to test the hardware. Therefore, main BIOS binary is loaded on ROM or its equivalent. After the OEM determines what software will be shipped with the PC, etc., a corresponding digital license containing the information of both software and hardware can be loaded to NVRAM or its equivalent at later manufacture process.

In addition to the above, the ACPI code varies from one type of motherboard to another. In accordance with the present invention, the OEMID and OEMTableID values in ACPI system table header that are part of compiled BIOS binary can be used as indirect identifier for the motherboard.

Thus, the ACPI BIOS code in main BIOS binary retrieves the digital license from NVRAM (or its equivalent) and the signature verifier from BIOS binary on ROM (or other special chip on motherboard), and presents the data in previously defined ACPI_SLIC structure to operating system.

While the present invention has been described in connection with the preferred embodiments of the various Figs., it is to be understood that other similar embodiments may be used or modifications and additions may be made to the described embodiment for performing the same function of the present invention without deviating therefrom. For example, one skilled in the art will recognize that the present invention as described in the present application may apply to any computing device or environment, whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A data structure embodied in a computer readable medium for use with an application, the application being suitable for deployment on a computing system, the data structure comprising:
a header field that includes information regarding said data structure contents; and
a software license structure that contains a digital signature and information regarding hardware and software in said computing system.

2. The data structure of claim 1, wherein said software license structure comprises a structure type field, a license data length field and a license data field.

3. The data structure of claim 2, wherein said license data field contains information regarding hardware within said computing system.

4. The data structure of claim 2, wherein said license data field contains information regarding software loaded onto said computing system.

5. The data structure of claim 2, wherein said license data field contains a timestamp.

6. The data structure of claim 1, wherein said application comprises a verifier that verifies said digital license and, wherein said verifier is exposed to an operating system installed on said computing system.

7. A method of populating a BIOS during manufacture of a personal computer, comprising:
loading a main BIOS binary; and
loading said BIOS with a software license structure that contains a digital signature and information regarding hardware and software in said computing system.

8. The method of claim 7, further comprising providing instructions in said main BIOS binary to retrieve a digital license and a signature verifier.

9. The method of claim 8, further comprising providing instructions in said main BIOS binary to present said digital license to an operating system installed on said personal computer.

10. A method of licensing hardware and software distributed with a computing device using a data structure, comprising:
providing said data structure in a BIOS contained within said computing device, said data structure including a header field that includes information regarding said data structure contents and a software license structure that contains a digital signature and information regarding hardware and software in said computing system;
providing a signature verifier that verifies said digital signature; and
providing said data structure to an operating system running on said computing device.

11. The method of claim 10, wherein said software license structure comprises a structure type field, a license data length field and a license data field.

12. The method of claim 10, wherein said license data field contains information regarding hardware within said computing system.

13. The method of claim 10, wherein said license data field contains information regarding software loaded onto said computing system.

14. The method of claim 10, wherein said license data field contains a timestamp.

15. The method of claim 10, further comprising providing instructions in a BIOS binary to retrieve a digital license and said signature verifier.
